(19) United States
(12) Patent Application Publication
(10) Pub. No.: US 2020/0397059 A1
(43) Pub. Date: Dec. 24, 2020

(54) Lava2 Vaporizer Device and Cartridge System

(71) Applicant: King Distribution, LLC, Clifton, NJ (US)

(72) Inventor: Gou Zongbo, Shenzhen (CN)

(73) Assignee: King Distribution, LLC, Clifton, NJ (US)

(21) Appl. No.: 16/448,206

(22) Filed: Jun. 21, 2019

(51) Int. Cl. A24F 47/00; A24F 7/02; H02J 7/00

(52) U.S. Cl. CPC A24F 47/008; H02J 2007/0062; H02J 7/0052; A24F 7/02

(57) ABSTRACT

The present disclosure relates to a rechargeable electronic vaporizing device for personal smoking that includes a shell and a proprietary combination mouthpiece and liquid storage component. The proprietary mouthpiece combination comprises three components: (1) an opaque first end with a through hole for the user to inhale vaporized liquid; (2) an opposite second end that includes the storage compartment for the liquid to be vaporized that is inserted into the shell; and (3) a third separating ridge that is preferably clear that separates the first end from the second end and also is in the same plane as the outer surface of the first end and the outer surface of the shell such that when the mouthpiece is inserted into the shell, an overall essentially smooth outer essentially single planar surface is formed with a clear ring separating the shell from the mouthpieces.

### FIELD OF THE INVENTION

The present disclosure is directed to a rechargeable electronic vaporizing device for personal smoking that includes a shell and a proprietary combination mouthpiece and liquid storage component. The proprietary mouthpiece combination comprises three components: an opaque first end with a through hole for the user to inhale vaporized liquid; an opposite second end that includes the storage compartment for the liquid to be vaporized that is inserted into the shell; and a third separating ridge that is preferably clear that separates the first end from the second end and also is in the same plane as the outer surface of the first end and the outer surface of the shell such that when the mouthpiece is inserted into the shell, an overall essentially smooth outer essentially single planar surface is formed with a clear ring separating the shell from the mouthpiece.

### BACKGROUND

Aerosol forming, electronically operated smoking systems are well known. So called ‘e-cigarettes’ have been developed as a presumably safer way to deliver nicotine, removing the burning of tobacco and paper. In 2003, it is believed that the first generation e-cigarette that used a piezoelectric element to vaporize a liquid containing nicotine diluted in a propylene glycol solution was developed.

Since then, many improvements have been developed. There are single-use disposable e-cigarettes consisting of a battery and cartridge containing an atomizer to heat a solution (with or without nicotine). Then, rechargeable e-cigarettes were developed and alternative shapes, such as the pen-style, rechargeable e-cigarette that is typically a little larger than a typical cigarette with a higher battery capacity and a refillable or replaceable liquid storage compartment.

E-cigarettes work by vaporizing a liquid, the vapor then simulating the smoke of a cigarette is inhaled. The liquid is typically a propylene glycol and glycerin mixture with additives such as flavorings, nicotine, and other additives for specific properties. When a user inhales, the airflow activates a flow sensor and a heating element then atomizes the liquid solution creating an aerosolized vapor. The inhaling is of this aerosol, mistakenly called a vapor and the act of smoking an e-cigarette is sometimes called ‘vaping.’

The user thus uses with a hand-to-mouth action and the e-cigarette produces an aerosol that resembles cigarette smoke and depending on the liquid that is aerosolized, a level of nicotine is delivered to the user. The user can have a cigarette smoking experience without the negative combustion tars and other undesirable effects of combustion associated with cigarette smoking.

There have been many attempts at evolving and customizing e-cigarette delivery systems between brands and catering to various users. For example, U.S. Pat. No. 8,794,231 B2 titled ELECTRICALLY HEATED SMOKING SYSTEM HAVING A LIQUID STORAGE PORTION, discloses, “an electrically heated smoking system includes a shell and a replaceable mouthpiece. The shell included an electric power supply and electric circuitry. The mouthpiece includes a liquid storage portion and a capillary wick having a first end and a second end. The first end of the wick extends into the liquid storage portion for contact with liquid therein. The mouthpiece also includes a heating element for heating the second end of the capillary wick, an air outlet, and an aerosol forming chamber between the second end of the capillary wick and the air outlet. When the shell and mouthpiece are engaged or connected, the heating element is in electrical connection with the power supply via the circuitry, and a flowpath for air is defined from at least one air inlet to the air outlet via the aerosol forming chamber. In use, liquid is transferred from the liquid storage portion towards the heating element be capillary action in the wick. Liquid at the second end of the capillary wick is vaporized by the heating element. The supersaturated vapor created, is mixed an carried in the air flow from the at least one air inlet to the aerosol forming chamber. In the aerosol forming chamber, the vapor condenses to form an aerosol, which is carried towards the air outlet.”

In another example, U.S. Pat. No. 10,070,669 B2 titled CARTRIDGE FOR USE WITH A VAPORIZER DEVICE, discloses, “a cartridge for generating an aerosol are provided. In some implementations, a cartridge comprises a body, a heating element, and a mouthpiece. The body includes a storage compartment configured to hold a vaporizable material and has a first end, a second end, and a surface between the first end and the second end. The mouthpiece is secured over the first end, has a notch extending away from the second end towards the first end, covers a first portion of the surface, does not cover a second portion of the surface configured for insertion into a cartridge receptacle of a vaporizer device, and does not cover a third portion of the surface comprising an area between the notch and the second end, the third portion of the surface being visible when the second portion of the surface is inserted into the cartridge receptacle.”

In another example, U.S. Pat. No. 10,045,568 B2 titled VAPORIZATION DEVICE SYSTEMS ANMD METHODS, discloses, “vaporizer devices and apparatuses [that] in some implementations, a cartridge for use with a vaporization device comprises a flattened body, a mouthpiece, a reservoir within the flattened body, a heater, and a pair of flat contact tabs. The flattened body comprises a proximal end, a distal end opposite the proximal end, a longitudinal axis between the proximal end and the distal end, and a transverse axis that is perpendicular to and shorter than the longitudinal axis. The mouthpiece is proximate to the proximal end of the flattened body, and the heater comprises of a pair of plates, a wick, and a resistive heating element. The pair of flat contact tabs are integrally formed from the plates and folded over an outer surface of the flattened body.”

Thus, these and other prior art e-cigarettes provide a functional, rechargeable, and refillable device, as well as devices where there is a replaceable, disposable, cartridge while the battery and circuitry shell remain re-useable.

It is an advantage to be able to see into the liquid storage chamber to view the liquid level remaining without having to remove the replaceable cartridge from the battery shell so that it can be known approximately how much life is left in the cartridge merely by looking. At least the device disclosed in the U.S. Pat. No. 10,070,669 B2 noted above, provides a ‘notch’ between the specially configured mouthpiece and the specially configured shell to provide a ‘window’ into the contents of the storage compartment. However, the window in taught in this patent is in a different planar surface area from the mouthpiece and shell, slightly sunken in. It is formed essentially by removing material from the mouthpiece and shell and thereby providing a view into the clear under storage compartment. Thus, the viewing component is depressed by the thickness of those materials. This sunken area can get caught on fabric (such as in a user's pocket or purse) and also can collect dust and dirt. Cleaning it would most likely involve removing the cartridge from the shell thereby defeating the purpose of the window in.

There remains a need, therefore, for a device with a replaceable cartridge that provides a simple window into the contents of the liquid storage compartment to be able to see into the liquid storage chamber to view the liquid level remaining without having to remove the replaceable cartridge from the battery shell so that it can be known approximately how much life is left in the cartridge, but all within essentially the same planar surface as the mouthpiece and shell so as to create one smooth continuous surface.

None of the foregoing references or any other known reference, alone or in combination, teach the salient and proprietary features of the present disclosure. None suggest a liquid storage chamber containing a circumferential ridge dividing and essentially joining the open edge of a mouthpiece with the open edge of a shell creating one, smooth continuous unit, while also providing a window into the chamber of the internal cartridge to view its level of contents.

The present disclosure teaches several embodiments of a proprietary e-cigarette storage and heating compartment with a properly configured shell comprising a battery and circuitry for activating the generation of aerosol/vapor by a user simply by inhaling.

In a preferred embodiment, there is provided an electrically heated smoking system comprising a shell comprising a rechargeable power supply and electric circuitry and a replaceable mouthpiece comprising a liquid storage compartment, a heating means, a wick extending into the liquid storage area one at least one end and a middle portion in contact with at least a portion of the heating means for forming the aerosol/vapor within a chamber connected to an outlet port to release the formed aerosol/vapor by drawing through the outlet port by the user. The proprietary mouthpiece comprises at least one air inlet and a means for contacting the heating means to the rechargeable power supply in the shell when the mouthpiece is engaged into the shell such that when so engaged, and a user then draws breath through the air outlet portal, an air flow path is activated, the electric circuitry is engaged and the power supply of the shell is engaged to provide power to the heating element, which in turn heats the liquid from the storage compartment that is wicked into an aerosol/vapor forming chamber via capillary action and brought to the center portion of the wick in contact with the heating means, this in turn then forms an aerosol/vapor to be drawn through the air outlet portal as part of the breath being drawn by the user.

In one embodiment, the shell may comprise an air inlet to allow air drawn into the shell be then drawn into the air inlet of the mouthpiece. In one embodiment, when the mouthpiece is inserted into the shell, the heating means comprises two contacts that contact respective contacts comprised within the rechargeable battery within the shell to transfer power from the rechargeable battery to the heating means.

### SUMMARY

The present disclosure teaches embodiments of a rechargeable electronic vaporizing device for personal smoking that comprise a proprietary combination mouthpiece and liquid storage component for use with a shell that provides a battery and electrical circuitry to activate aerosolization of a contained liquid into a breathable expelled stream. The proprietary mouthpiece combination comprises three components: (1) an opaque first end with a through hole for the user to inhale aerosolized/vaporized liquid; (2) an opposite second end that includes a preferably clear storage compartment for the liquid to be aerosolized/vaporized that is insertable into a properly configured shell; and (3) a third separating ridge that is preferably clear that separates the first end from the second end and whose outer surface is in the same plane as the outer surface of the first end and the outer surface of the shell such that when the mouthpiece is inserted into the shell, an overall essentially smooth and single planar outer surface is formed with a clear ring separating the shell from the mouthpiece.

The present disclosure provides a proprietary e-cigarette replaceable liquid storage compartment mouthpiece configured to be inserted into a properly configured shell comprising:
i. an opaque first end with a through hole configured to allow a user to inhale and create an air flow path through said through hole;
ii. a second opposite end comprising a liquid storage compartment, a wick having at least one end exposed into said liquid storage compartment and a middle, a heating means comprising electrical contacts and a heating component in contact with said middle portion of said wick, an aerosol/vapor forming chamber surrounding the middle portion of said wick in contact with said heating means, and an at least one air inlet, configured to create an air flow path from the at least one air inlet into the aerosol/vapor forming chamber and to the through hole, and further configured to combine with said properly configured shell such that the electrical contacts contact reciprocal electrical contacts of a rechargeable battery within said shell; and
iii. a third clear raised ridge separating the opaque first end from the second opposite end and configured to be in the same plane as the outer surface of the opaque first end and the outer surface of a properly configured shell such that when the mouthpiece is inserted into the shell, a substantially smooth, single planar surface area is formed with a clear ring separating the mouthpiece and shell.

In one embodiment, the vaporizer device disclosed herein when fully assembled and ready for use, resembles a flattened cylinder, approximately the length of a standard cigarette, with an opaque mouthpiece at one end, a relatively longer opaque opposite end that the user would typically hold when using, and a clear curved band separating while seamlessly joining the two just described ends.

In one embodiment, the clear curved band provides a window into a liquid storage compartment to view at least some of its contents, namely, at least the liquid that is stored. One of skill in the art will appreciate the desired combination of visibility into the liquid storage compartment, aesthetic properties, mating the edges of the mouthpiece and the shell to provide a smooth seemingly one-piece surface, and other attributes described herein, to determine desired thicknesses and curvatures of the raised ridge.

In one embodiment, the shell comprises a rechargeable battery, rechargeable via a USB input. In alternative embodiments, the rechargeable battery could be replaceable single-use batteries.

In one embodiment, the shell comprises electronic circuitry that controls the delivery of electricity from the battery to the heating means when contact is made and breath is drawn through the device to deliver an appropriate electric charge to a resistance coil to heat a liquid to produce a desired aerosol/vapor at a constant or desired flow rate.

In one embodiment, the shell also comprises an indicator light to demonstrate that sufficient charge remains in the battery to deliver an appropriate charge when breath is drawn and that the device is in-use.

In one embodiment, the shell also comprises an air hole to allow air to be drawn into the mouthpiece/liquid storage compartment combination when a breath is drawn through the mouthpiece/liquid storage compartment combination that is properly inserted into the shell. This air hole is configured to be of a desired size to allow a desired air flow based on the strength of the breath drawn based on the physics of air flow dynamics through a round aperture.

In one embodiment, the shell also comprises at least one notch that will grip an appropriately configured area on a mouthpiece/liquid storage compartment combination when it is inserted into the shell. In this embodiment, the mouthpiece/liquid storage compartment combination should insert easily into the shell, snap in place, and not fall out unless and until a user applies a minimal pressure to pull it out for replacement. In one embodiment, there will be two notches, one on either side of the shell, for even insertion and removal pressure.

In one embodiment, the mouthpiece/liquid storage compartment combination is provided to a user pre-assembled such that the mouthpiece is already in-place over a first end of the liquid storage compartment and seamlessly abutting the raised ridge and ready for insertion into the shell.

In one embodiment, the mouthpiece/liquid storage compartment combination comprises a gasket between the mouthpiece and the first end of the liquid storage compartment that is configured to regulate the air flow through the device. In one embodiment, the gasket is configured to properly seat the mouthpiece against the first end of the liquid storage compartment and may be adjusted with packing material to properly seat the gasket in place. In one embodiment, the packing material may also be absorbent to prevent the user from getting any extraneous liquid from aerosol/vapor that has recondensed or simply leaked.

In one embodiment, the mouthpiece/liquid storage compartment combination comprises an internal aerosol/vapor forming chamber within the liquid storage compartment, further comprising a wick that has at least one end in the liquid and a middle portion inside the internal chamber into which the liquid is drawn. In this embodiment, the wick also has a heating means in contact such that when a breath is drawn, the heating element heats the liquid being wicked into the internal chamber sufficient to form the aerosol/vapor that is then expelled through a through hole and into the breath being taken by the user. When the breath is stopped, the heating means is stopped and the aerosol/vapor formation is stopped.

In one embodiment, the mouthpiece/liquid storage compartment combination is configured to be inserted into a properly configured shell such that the exposed edge of the raised ridge will juxtapose and abut against the edge of the shell in the same manner as it is already abutting the edge of the mouthpiece on its opposite side.

### BRIEF DESCRIPTION OF THE DRAWINGS

FIG. 1 depicts an exploded view of an embodiment of a mouthpiece/liquid storage container as described herein with an opaque mouthpiece (1) that fits over the liquid storage container (2) that comprises a clear raised ridge (3), a heating means (4), a wick (5), and a gasket (6) to secure and regulate a through hole (7), the entire device when fully assembled configured to be inserted into a properly configured shell (8) comprising a rechargeable battery and electrical circuitry (not shown).

FIG. 2 depicts a view of an embodiment of a mouthpiece/liquid storage compartment as described herein and shown in FIG. 1, assembled and ready for insertion into a properly configured shell (8) as indicated by the arrow, comprising an opaque mouthpiece (1) at a first end, an opposite end comprising the liquid storage compartment (2), a clear raised ridge (3) separating the ends, and all of the other elements as shown in FIG. 1.

FIG. 3 depicts an overall view of an embodiment of a mouthpiece (1) as described herein inserted into a properly configured shell (8) and comprising a clear raised ridge (3) separating the mouthpiece from the shell and also joining them in a substantially singular planar smooth surface. In this embodiment, the clear raised ridge (3) is clear while the mouthpiece (1) and shell (8) are opaque such that the clear raised ridge provides a window into the interior of the mouthpiece/liquid storage compartment and in this view, the through hole (7) is visible.

FIG. 4 depicts an embodiment an embodiment of a mouthpiece (1) as described herein inserted into a properly configured shell (8) and comprising a clear raised ridge (3) separating the mouthpiece from the shell and also joining them in a substantially singular planar smooth surface, with dotted lines to illustrate internal hidden components as illustrated in other FIGs when inserted. In this view and embodiment, also depicted are an internal notch (9) within the shell that meets with similarly configured point on the outside of the mouthpiece/liquid storage compartment to secure and snap in place when inserted; as well as a small air hole (10) to allow a regulated air flow when a user draws a breath through the mouthpiece, and battery contacts (11) to provide the required circuitry connection.

FIG. 5 depicts an embodiment of an exploded view of just the mouthpiece/liquid storage compartment showing a preferred configuration of an opaque mouthpiece (1), a liquid storage compartment (2) containing a raised ridge (3), a heating means (4), a wick (5), said heating means connected to battery terminal connections (11) and disposed within a heating chamber (17) wherein said wick (5) extends into a liquid contained within the storage compartment and comes into contact with said heating means within said heating chamber, a through hole (7) having an end (12) that allows air drawn into the heating chamber and then through the through hole and then through a regulation means (16) in the gasket (6) to control air flow through the mouthpiece. Also depicted are an embodiment of a filler hole (14) to allow liquid into the storage compartment and then plugged, a notch in the storage compartment (15) to secure the opaque mouthpiece over it and a friction band (13) to secure the mouthpiece/liquid storage compartment in the shell when inserted.

FIG. 6 depicts an embodiment of the liquid storage compartment (2) showing a preferred configuration of said liquid storage compartment (2) containing a raised ridge (3), a heating means (4), a wick (5), said heating means connected to battery terminal connections (11) and disposed within a heating chamber (17) wherein said wick (5) extends into a liquid contained within the storage compartment and comes into contact with said heating means within said heating chamber, a through hole (7) having an end (12) that allows air drawn into the heating chamber and then through the through hole (7). Also depicted are an embodiment of a filler hole (14) to allow liquid into the storage compartment and then plugged, a notch in the storage compartment (15) to secure a mouthpiece (not shown) over it and a friction band (13) to secure the mouthpiece/liquid storage compartment in the shell (not shown) when inserted.

FIG. 7 depicts an embodiment of an outline of a preferred embodiment of a liquid storage compartment (2) depicting the raised ridge (3) that separates a first area of the storage compartment (23) that is configured to accept an opaque mouthpiece covering from a second area of the storage compartment (24) that is configured to insert into a correspondingly configured shell.

FIG. 8 depicts an exploded view of an embodiment of the mouthpiece (1), viewing into its opening from underneath that slips over the liquid storage compartment (2), showing two mouthpiece air flow openings (18) and a depressed area (19), over which the gasket (6) sits (as indicated by the arrow), said gasket having on through air vent (16) sitting on a raised area (20). In one embodiment, when the gasket (6) is inserted into the mouthpiece (1), packing material (not shown) can be used to properly seat the gasket into position and create the proper airflow prior to inserting the combined mouthpiece and gasket over the liquid storage compartment (as indicated by the arrow). As illustrated, looking down through the through hole (7) of the liquid storage compartment (2), in view is the heating element (4) and also depicted is a seating area (21) to keep the gasket in place over the liquid storage compartment. Looking down in this view, also visible is the raised ridge (3) that circumnavigates the entire outer surface of the liquid storage compartment (2).

### DETAILED DESCRIPTION

For clarity of disclosure, and not by way of limitation, the detailed description of the invention is divided into the following subsections that describe or illustrate certain features, embodiments or applications of the present invention.

### Definitions

“mouthpiece” as used herein means any covering, configured to provide a suitable outer surface over the end of an electronic vaping device to be used by a user to insert into the user's mouth and allow a draw of air by inhaling.

“liquid storage compartment” as used herein means a compartment configured to hold a pre-determined amount of liquid suitable for use in an electronic vaping device wherein such liquid can produce an aerosol/vapor.

“raised ridge” as used herein means a pre-determined amount of material configured on a liquid storage compartment that separates a mouthpiece from a shell when a mouthpiece/liquid storage compartment combination is inserted into a shell and is substantially clear to allow a view into the liquid storage compartment and is further configured to form a substantially singular planar surface across the outer surface of the mouthpiece to the raised ridge to the shell.

“shell” as used herein means a device properly configured to receive a mouthpiece/liquid storage compartment combination comprising electronic circuitry and a rechargeable power means to control a user's use of the fully assembled device by allowing the user to draw a breath through the mouthpiece, activating the aerosolization/vaporization of liquid stored in the liquid storage compartment, and drawn through the through hole and into user's body.

### The System and Method of the Present Invention

The present disclosure teaches embodiments of an electronic vaping device.

With regard to electronic vaping devices generally, it is a preferred functionality to be able to know how much liquid remains in a liquid storage compartment at any point in using such a device. It is possible that the entire casing for all working components be clear and all parts, as well as liquid, could be viewed. However, as electronic vaping devices have evolved, it appears that aesthetically, it has been desirable that they appear more like traditional cigarettes or other smoking implements, i.e., that you are actually smoking and not inhaling a vaporized/aerosolized liquid. Thus, traditionally, electronic vaping devices have been fully opaque, with some actually mimicking traditional cigarettes, being round, white at its shell end, and producing an orange light at its white end to mimic burning.

In one embodiment, it is desirable to produce a view into the liquid storage compartment to view its contents remaining. It is also desirable however, not to change the overall appearance of the outer surface of the device. By providing a cutout, either in the shell, the mouthpiece, or both, a view into the underlying liquid storage compartment can be had. However, in this configuration, the cutout provides an indentation with edges that can catch on material, such as in a user's pocket or purse, and/or also be a repository for dirt, dust and the like. It would be possible to provide a traditional window in this cutout area, an extra piece of clear plastic that could insert into the cutout area to create a smooth outer surface and still leave the same view into the underlying liquid storage compartment. However, this creates extra, complicated manufacturing steps and would tend to join more permanently the mouthpiece with the shell.

In one embodiment, provided here is a clear raised ridge, dividing the underlying liquid storage compartment into three areas, namely, a first area that is configured to accept an opaque mouthpiece covering, a second opposite end area that is configured to insert into an appropriately configured shell, and a third raised clear material area that creates both the divide between the mouthpiece and the shell and the viewing area into the underlying liquid storage compartment. In this embodiment, the clear raised ridge is a raised material with a height that matches exactly the thickness of the wall of the mouthpiece on one side and the wall of the shell on its opposite side. In one embodiment, this thickness is the same, but could be varied with a slope if the mouthpiece and the shell walls have different thicknesses.

In one embodiment, the raised ridge circumnavigates the entire liquid storage compartment and creates a clear line of divide all the around the device. In an alternative embodiment, the mouthpiece and shell could be designed to meet directly on one side with the raised ridge only on one side of the liquid storage compartment dividing the mouthpiece and shell only on one side. In an alternative embodiment, the raised ridge could circumnavigate any desired amount around the device with the mouthpiece and shell being appropriately configured to match.

In one embodiment, the device as taught herein comprises a mouthpiece/liquid storage compartment combination that is a single use cartridge that a user may plug into an appropriately configured shell, use until the liquid is used up (or not, in some instances, a user may simply desire a different flavor), and then remove and replace with a different cartridge.

In one embodiment, the device as taught herein will provide a view into the liquid storage compartment such that a user may know the contents remaining without having to remove the inserted mouthpiece/liquid storage compartment combination.

In one embodiment, the clear raised ridge circumnavigates the entire surface around of the liquid storage compartment. In one embodiment, the clear raised ridge circumnavigates only a portion of the way around the surface of the liquid storage compartment, with the edge of the mouthpiece and the edge of the shell appropriately configured to meet at the areas where the clear raised ridge is not present. In one embodiment, the edge of at least one of the sides of the clear raised ridge is not smooth, but comprises a design. The design could be any aesthetically pleasing shape such as a zig-zag design, or waves, or curves. In one embodiment, the design could be on both edges.

### Examples

The present invention is further illustrated, but not limited by, the following examples.

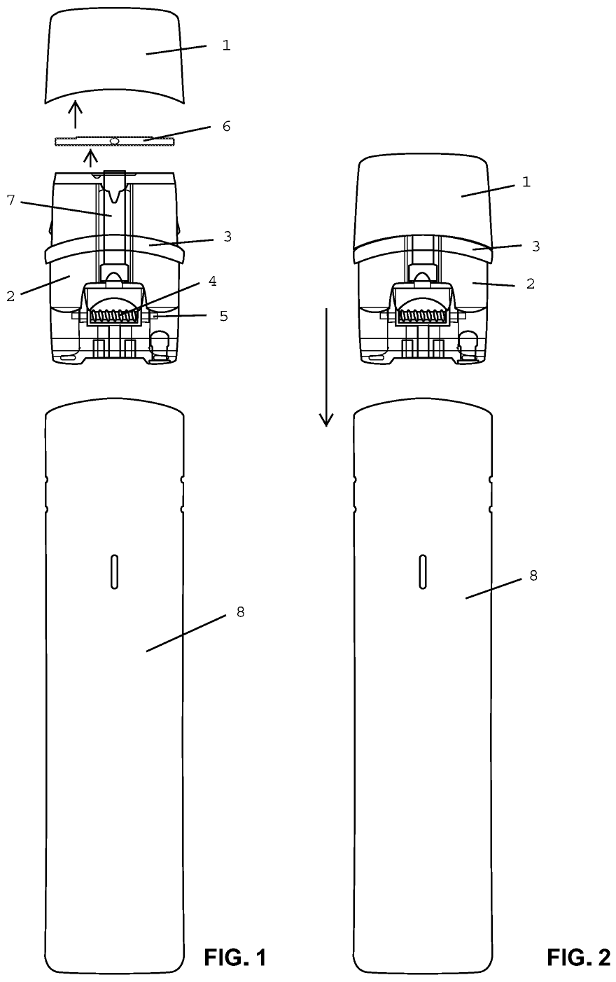

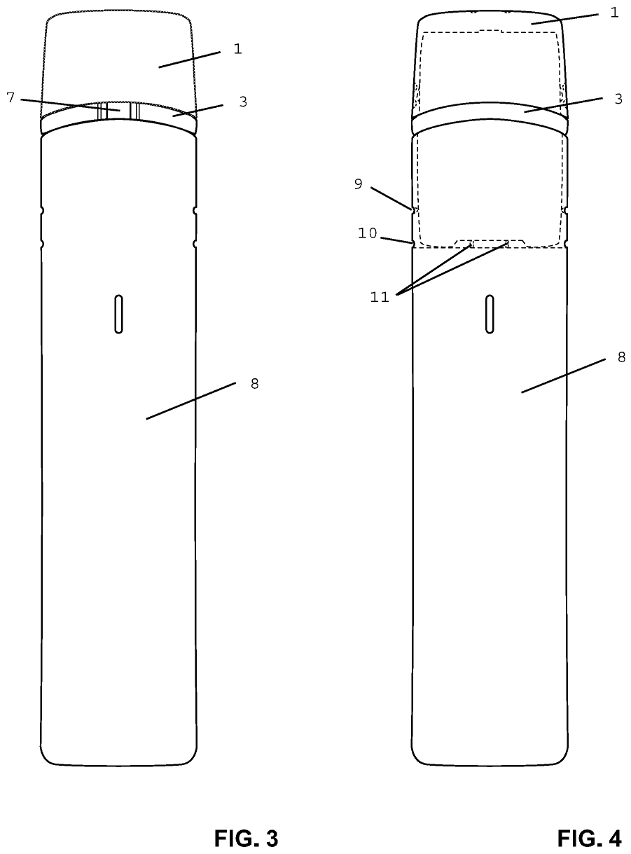

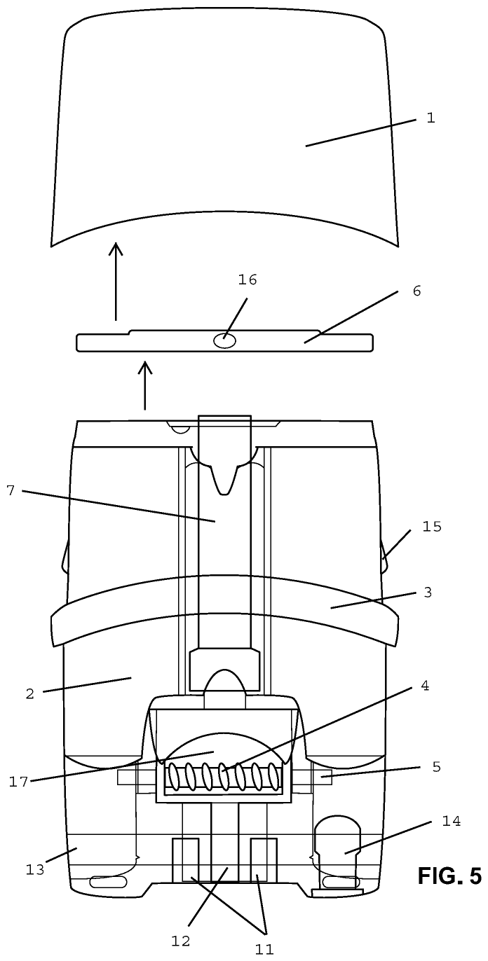

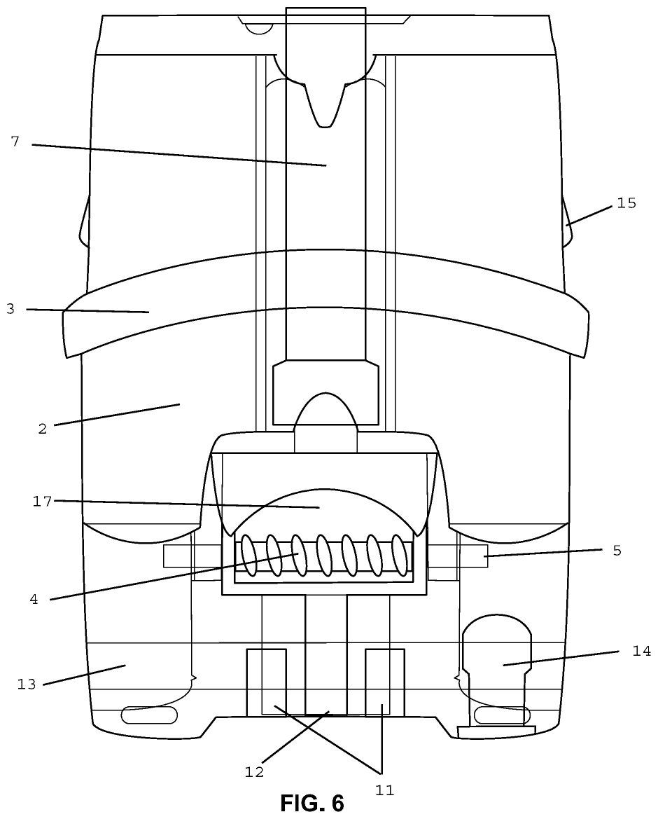

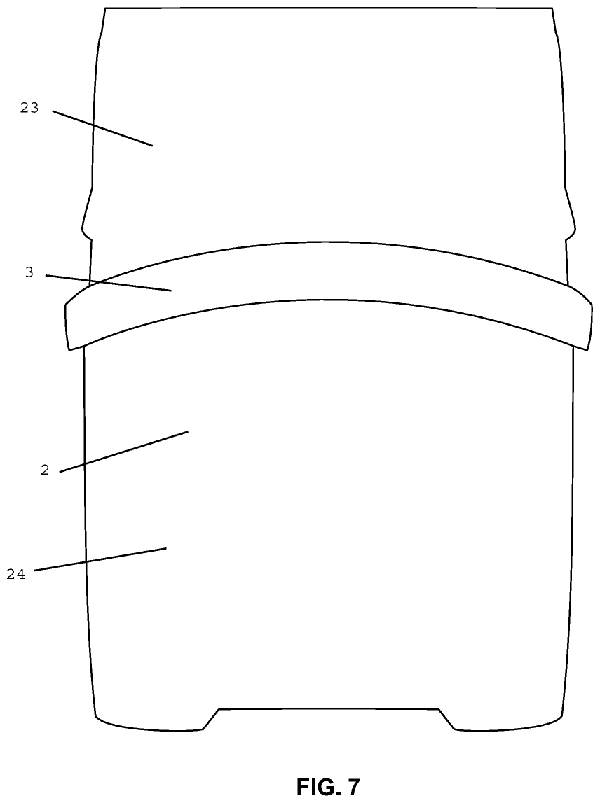

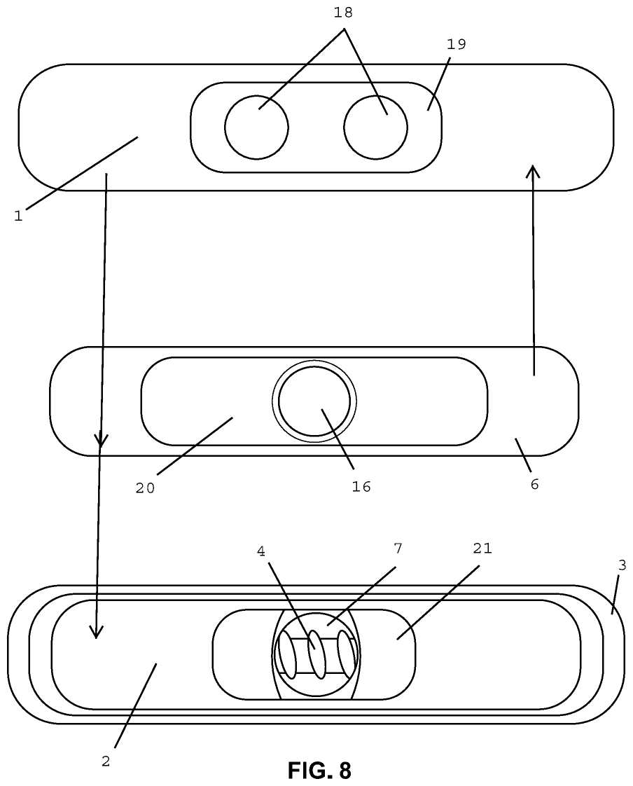

In one embodiment, referring to FIGS. 1 and 2, a liquid storage compartment comprises an internal vapor/aerosol forming chamber that itself comprises a wick and a heating means, a first end with a through hole configured to receive an opaque mouthpiece covering, and the combination configured to insert into a shell and when so inserted, a clear raised ridge both joins the end of the mouthpiece with the end of the shell and also separates them to provide a window into the underlying liquid storage compartment. See FIG. 3.

In one embodiment, the mouthpiece/liquid storage compartment combination is provided to a user fully assembled as a cartridge pre-filled with liquid and ready to use with an appropriately configured shell.

In one embodiment, a user purchases a package containing a shell and any number of mouthpiece/liquid storage compartment combination cartridges. Each such cartridge is a single-use cartridge insertable into and removeable from the shell. Because of the raised ridge, the user can know approximately how much liquid remains in the cartridge at any time and can therefore estimate if they need to bring with them additional cartridges for a day or night of use, and when it will become necessary to change cartridges during use.

In one embodiment, the shell comprises a rechargeable battery which could be recharged via a USB connection or any wall charger connection. The user could simply plug in the shell at night to an appropriate connection, such as a USB port, and the next morning, the shell will have sufficient charge to use in a typical fashion for the entire next day and/or night.

In one embodiment, different cartridges could have different liquids in them for varying the user's experience. They could have varying levels of nicotine or other desirable additive. They could have various flavors.

In one embodiment, by varying the size of the raised ridge, the size of the liquid storage compartment could be varied without varying the size of the mouthpiece or the shell. In a preferred embodiment, the size of the liquid storage compartment will contain enough liquid to deliver nicotine equivalent to approximately that of a standard pack of cigarettes.

In one embodiment, a user would also be able to purchase additional cartridges separately for use with the single shell. In one embodiment, the cartridges will come with a color coded covering over the end that inserts into the shell. In this embodiment, the user will know what kind of liquid is pre-filled into the cartridge. For example, if the covering is green, the liquid may be mint flavor. The user reaches into his pocket, pulls out a cartridge and sees the green covering, knows it is the desired mint flavor, removes the green covering and inserts it into the shell. The shell joins with the exposed edge of the raised ridge, the battery contacts on the end of the cartridge contacting their counterparts in the shell, the raised ridge now separating the mouthpiece from the shell and leaving a window into the underlying liquid storage compartment, but also joining the ends with an overall smooth outer surface, and creating a useable fully active electronic vaping device. As the user uses this device, they will be able to see the liquid at any viewing angle at any point around the circumference of the device.

Publications cited throughout this document are hereby incorporated by reference in their entirety. Although the various aspects of the invention have been illustrated above by reference to examples and preferred embodiments, it will be appreciated that the scope of the invention is defined not by the foregoing description but by the following claims properly construed under principles of patent law.

Each and every feature described herein, and each and every combination of two or more of such features, is included within the scope of the present invention provided that the features included in such a combination are not mutually exclusive.

What is claimed is:

1. A replaceable liquid storage compartment and mouthpiece combination device configured to be inserted into a properly configured shell comprising:
i. an opaque first end with a through hole configured to allow a user to inhale and create an air flow path through said through hole;
ii. a second opposite end comprising a liquid storage compartment, a wick having at least one end exposed into said liquid storage compartment and a middle, a heating means comprising electrical contacts and a heating component in contact with said middle portion of said wick, an aerosol/vapor forming chamber surrounding the middle portion of said wick in contact with said heating means, and an at least one air inlet, configured to create an air flow path from the at least one air inlet into the aerosol/vapor forming chamber and to the through hole, and further configured to combine with said properly configured shell such that the electrical contacts contact reciprocal electrical contacts of a rechargeable battery within said shell; and
iii. a third middle area between said first end and said second opposite end comprising a clear raised ridge circumnavigating the entire liquid storage compartment separating the opaque first end from the second opposite end and configured to have its outer surface be in the same plane as the outer surface of the opaque first end and the outer surface of a properly configured shell such that when the mouthpiece is inserted into the shell, a substantially smooth, single planar surface area is formed with a clear ring separating the mouthpiece and shell.

2. The device of claim 1 wherein the clear raised ridge circumnavigates only a portion of the entire way around the liquid storage compartment, with the ends of the mouthpiece and shell appropriately configured to meet directly in the areas where the clear raised ridge does not separate them.

3. The device of claim 1 wherein the clear raised ridge is of different heights at its opposite ends to accommodate a mouthpiece wall thickness different from a shell wall thickness.

3. The device of claim 1 wherein the clear raised ridge is curved.

4. The device of claim 1 wherein the clear raised ridge is straight.

5. The device of claim 1 wherein the clear raised ridge comprises a design on at least one of its edges.

6. The device of claim 5 wherein the design is a zig-zag shape.

7. The device of claim 5 wherein the clear raised ridge comprises a design on both of its edges.
